(19) United States
(12) Patent Application Publication
(10) Pub. No.: US 2016/0377809 A1
(43) Pub. Date: Dec. 29, 2016

(54) Optical Edge Coupling With A Separate Trimmed Taper

(71) Applicant: Futurewei Technologies, Inc., Plano, TX (US)

(72) Inventors: Li Yang, San Jose, CA (US); Huapu Pan, Rye, NY (US); Yu Sheng Bai, Los Altos Hills, CA (US); Xiao Andy Shen, San Bruno, CA (US)

(21) Appl. No.: 14/750,637

(22) Filed: Jun. 25, 2015

(51) Int. Cl. G02B 6/14; G02B 6/30; G02B 6/136

(52) U.S. Cl. CPC G02B 6/14; G02B 6/136; G02B 6/305

(57) ABSTRACT

A method includes forming a first optical structure with an inverse taper and a separate optical structure on a semiconductor chip. The illustrative method also includes applying a protective structure over the optical structures and patterning the protective structure to expose the separate optical structure. The method further includes removing a portion of the separate optical structure to form a separate trimmed taper separate from, but adjacent to, the first optical structure. The protective structure is then removed from the first optical structure. Apparatuses are also disclosed.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In optical transceivers, photonic integrated circuits (PICs) interface with other optical components such as fibers, lasers, and other PICs. Edge coupling is an approach that allows a PIC to optically interface with other optical components. The PIC may include an edge coupling device that permits an external optical component to be optically coupled to a waveguide on the PIC.

Typically, mode sizes in PIC waveguides are quite small. Mode size refers to the dimension of a mode in an optical waveguide in a certain direction, for example, the energy distribution in the transverse direction. For example, the mode size of a typical 450 nanometer (nm) by 220 nm waveguide in a silicon-photonic-based PIC is about the size of the waveguide itself, which is much smaller than the mode diameter of a standard 9.2 micrometer (μm) single-mode fiber. Additionally, there are often differences in mode shape between the PIC waveguides and other optical components such as lasers. Mode shape refers to the relative dimension of the mode size in two different directions, for example, a horizontal direction and a vertical direction. An optical signal comprises one or more information signals (e.g., data signals) that are imposed onto optical wavelengths. For example, an optical wavelength may be in the visible spectrum or near infrared, for example, from about 850 nm to about 1650 nm. Optical signals that are allowed to travel through a waveguide are referred to as modes (e.g., modes of light) and groups of allowed modes form bands. A waveguide has a finite number of guided propagation modes which can support one or more modes. For example, a single mode waveguide has a single guided mode per polarization direction. The number of modes, the transverse profile amplitude of the modes, and the propagation constants for the modes depend on the waveguide structure and the wavelength of an optical signal. An improper horizontal to vertical ratio of the mode shape can reduce coupling efficiency.

As noted above, often the mode size of an optical component (e.g., fiber) to be optically coupled to a PIC is much larger than the mode size of the edge coupling device of the PIC. For example, the mode size of the optical component may be several hundred times as large as the mode size of the waveguide itself on the PIC's edge coupling device. A mismatch in mode size of the optical component and the edge coupling device of a PIC may cause poor coupling efficiency.

### SUMMARY

In one embodiment, the disclosure describes a method that includes forming a first optical structure with an inverse taper and a separate optical structure on a semiconductor chip. The illustrative method also includes applying a protective structure over the optical structures and patterning the protective structure to expose the separate optical structure. The method further includes removing a portion of the separate optical structure to form a separate trimmed taper separate from, but adjacent to, the first optical structure. The protective structure is then removed from the first optical structure.

In another embodiment, an apparatus includes an optical structure configured to pass light therethrough. The optical structure includes an inverse taper defining an optical mode. The optical structure also includes a separate trimmed taper provided separate from, but adjacent to, the inverse taper of the optical structure. The separate trimmed taper defines an optical mode. The optical mode of the separate trimmed taper is larger than the optical mode of the inverse taper of the optical structure.

Yet another embodiment is directed to a photonic integrated circuit (PIC) that includes an optical element and an edge coupling device. The edge coupling device includes an optical structure and separate trimmed taper. The optical structure includes an inverse taper. The optical structure is configured to provide light signals to the optical element for further processing of the light signals. The separate trimmed taper is provided separate from, but adjacent to, the inverse taper of the optical structure. The separate trimmed taper is configured to receive light signals from an optical device that is external to the PIC.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an optical system in accordance with various embodiments.

FIG. 2 is a perspective view of the edge coupling device including an optical structure and a separate trimmed taper in accordance with various embodiments.

FIG. 3 is a top-down view of a waveguide with an adjacent separate trimmed taper.

FIG. 4 is a top-down view of a power splitter with an adjacent separate trimmed taper.

FIG. 5 is a top-down view of a Y-junction with an adjacent separate trimmed taper.

FIG. 6 is a method for fabricating an edge coupling device in accordance with various embodiments.

FIGS. 7A, 7B, 7C, 7D, and 7E illustrate various processing steps of fabricating the edge coupling device in accordance with various embodiments.

FIGS. 8A, 8B, 8C, 8D, and 8E illustrate various processing steps of fabricating the edge coupling device in accordance with other embodiments.

FIGS. 9A, 9B, 9C, 9D, 9E, and 9F illustrate various processing steps of fabricating the edge coupling device in accordance with yet other embodiments.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for bridging the gap between the mode size of an optical component and a mode size of an edge coupling device on a PIC. The edge coupling device permits the external optical component (external to the PIC) to be optically coupled to the PIC so that the PIC can process light signals from the optical component. The disclosed edge coupling device includes an optical structure (e.g., a waveguide, power splitter, Y-junction, etc.) and a separate trimmed taper (separate from the optical structure). The optical structure includes an inverse trimmed taper which provides for a larger mode size at its tip than the remaining portion of the optical structure. However, the larger mode size still may not be large enough to match the mode size of the external optical component to be coupled to the PIC. By including a separate trimmed taper, which also includes an inverse taper, the tip of the separate trimmed taper can more readily be made smaller than that of the optical structure, thereby providing an even larger mode size more suitable for coupling to the external optical component. As such, light from the external optical component may be received into the separate inverse taper, and then from the separate inverse taper into the optical structure. From the optical structure, the light signals may be provided to other optical elements on the PIC for further processing. In some embodiments, the edge coupling device (optical structure and separate inverse taper) is a bi-directional coupling device for the PIC and thus may receive light signals from the external component as well as transmit light signals to the external component.

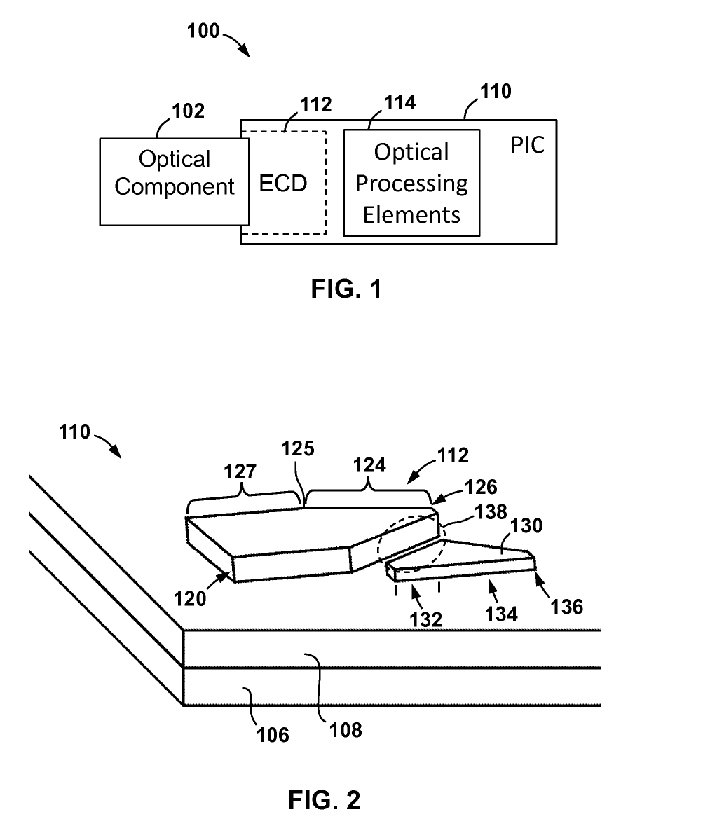

FIG. 1 is a schematic diagram of an example of an optical system 100 that includes an external optical component 102 optically coupled to a PIC 110. The PIC 110 includes an edge coupling device 112 which provides an optical interface for the optical component 102. System 100 is configured to communicate optical signals between the optical component 102 and the PIC 110 via the PIC's edge coupling device 112. The external optical component 102 may any of a variety of types of components such as an optical fiber, a laser diode, a light emitting diode (LED), another PIC, a waveguide, a fiber coupler, a fiber connector, a fiber collimator, etc. Edge coupling device 112 is configured to communicate an optical signal received from the optical component 102 to optical processing elements 114 on the PIC 110. Such optical processing elements 114 may perform any of a variety of elements such as an optical amplifier, an optical multiplexer and/or demultiplexer, and an optical-to-electrical converter. The PIC 110 preferably is a semiconductor chip that integrates the optical processing elements 114 as well as the edge coupling device 112. Any of a variety of semiconductor processing steps may be employed to fabricate PIC 110.

FIG. 2 shows an example of at least a portion of PIC 110. In the example of FIG. 2, PIC 110 includes one or more layers 106, 108 on which the edge coupling device 112 is provided. Layer 106 may be a silicon layer and layer 108 may be a low index layer (e.g., silicon dioxide). In some examples, the edge coupling device 112 may be formed on layer 108 through various semiconductor processing techniques as those described below.

The edge coupling device 112 shown in FIG. 2 may include an optical structure 120. In some implementations, the optical structure 120 may comprise an optical waveguide, an optical power splitter, an optical Y-junction, or other type of optical structure. In the particular example of FIG. 2, the optical structure 120 is a waveguide. One end of the waveguide is formed into an inverse taper 124. The edge coupling device 112 also includes a separate trimmed taper 130 provided separate from, but adjacent to, the optical structure 120 (e.g., waveguide). The separate trimmed taper 130 is configured to receive optical signals from the optical structure 120 (FIG. 1) and provide the optical signals to the optical component 102, which is external to the PIC 110. The separate trimmed taper 130 is also configured to receive optical signals from an optical component 102 (FIG. 1). Optical signals received by the separate trimmed taper 130 from the external optical component 102 are provided to the optical structure 120, and from the optical structure 120 to one or more of the PIC's optical processing elements 114. Thus, the optical signal path may be bi-directional.

The inverse taper 124 of the optical structure 120 has a cross-sectional area that decreases from point 125 to tip 126. To the left of point 125 in FIG. 1, the cross sectional area of the optical structure 120 is generally constant along portion 127. To the right of point 125, the cross sectional area of the optical structure 120 tapers from a larger cross sectional area at point 125 to a smaller cross sectional area at tip 126 to form the inverse taper 124. The shape of the cross section may be rectangular or another shape.

The separate inverse taper 130 is separate from, but adjacent to, the inverse taper 124 of the optical structure 120. In this example, the separate inverse taper 130 partially overlaps the inverse taper 124 of the optical structure 120 along portion 132 and as further indicated by dashed oval 138. The separate inverse taper 130 also includes a portion 134 that extends past the tip 126 of the optical structure's inverse taper 124. Portion 134 of the separate inverse taper 130 terminates at tip 136. In various embodiments, the optical mode of the separate trimmed taper 130 at tip 136 is larger than the optical mode of the inverse taper 124 of the optical structure 120 at tip 126. The larger mode size at tip 136 is made possible in some embodiments by forming and processing the trimmed taper 130 separate from optical structure 120. That is, the semiconductor processing performed on separate trimmed taper 130 can be performed so as to make the cross sectional area of tip 136 small enough to achieve a sufficiently large mode size for efficiently coupling the separate trimmed taper 130 to external optical component 102, and in a way that does not affect the size and shape of the optical structure's inverse taper 124. Without the separate inverse taper 130, in some examples it might not be possible to make the tip 126 of the inverse taper of the optical structure small enough to achieve a sufficiently large mode size without also impacting other portions of the optical structure.

In some embodiments, the width of the tip 136 of the separate inverse taper 130 is smaller than the width of tip 126 of the inverse taper 124 of the optical structure 120. By way of an example, the width of tip 126 may be in the range of 80 nanometers (nm) to 200 nm, while the width of tip 136 of the separate inverse taper 130 is the range of 5 nm to 150 nm. While the possible tip width ranges may overlap, tip 136 of the separate inverse taper 130 preferably has a smaller width than tip 126 of the optical structure 120. In some embodiments, the height of the tip 136 of the separate inverse taper 130 is smaller than the height of tip 126 of the inverse taper 124 of the optical structure 120. By way of an example, the height of tip 126 may be in the range of 200 nanometers (nm) to 240 nm, while the height of tip 136 of the separate inverse taper 130 is the range of 60 nm to 200 nm. While the possible tip height ranges may overlap, tip 136 of the separate inverse taper 130 preferably has a smaller height than tip 126 of the optical structure 120. In some embodiments, tip 136 of the separate inverse taper 130 preferably has both a smaller width and a smaller height than tip 126 of the optical structure 120.

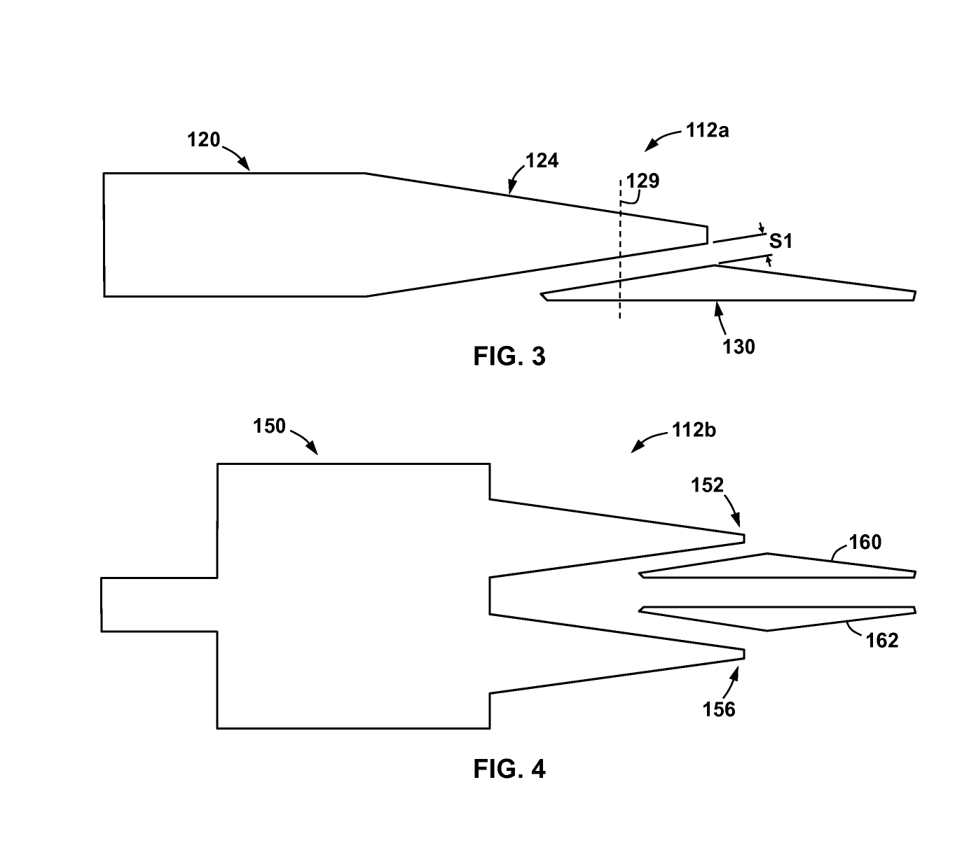

FIG. 3 illustrates a top-down view of the edge coupling device 112 of FIG. 1, designated by reference numeral 112a in FIG. 3. The edge coupling device 112a includes an optical structure 120 (e.g., waveguide) with an inverse taper 124 and a separate inverse taper 130, as described above. The separation between the inverse taper 124 of the optical structure 120 and the separate inverse taper 130 is shown as dimension S1. Dimension S1 can be any suitable distance. In some embodiments, S1 is in the range of 80 mm to 600 mm.

FIG. 4 shows an example of an edge coupling device 112 (designated in FIG. 4 by reference numeral 112b) in which the optical structure 120 is provided in the form of a power splitter 150. Power splitter 150 includes multiple tips 152 and 156, which operate to split an incident optical beam into multiple (2 in the example FIG. 4) output optical beams. The power of the incidence beam may be split evenly or unevenly among the output optical beams. A plurality of separate trimmed tapers 160, 162 are provided as well in the example of FIG. 4, with each separate trimmed taper provided separate from, but adjacent to, one of the tips 152, 156 of the power splitter. The split output beams from tips 152 and 156 are provided into each corresponding separate trimmed taper. Thus, the beam from tip 152 is provided into separate trimmed taper 160, and the beam from tip 156 is provided into separate trimmed taper 162. In the end, the trimmed tapers 160 and 162 may merge the beam into one mode. The dimensions of and gaps between the trimmed tapers 160 and 162 can define the mode profile of the optical beam.

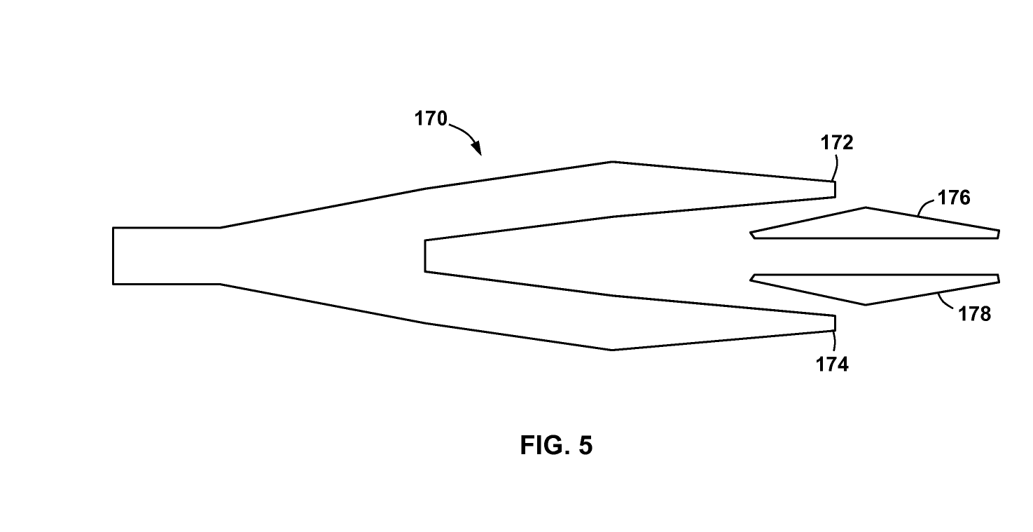

FIG. 5 shows another example of edge coupling device 112, shown as a Y-junction 170. The Y-junction 170 of the example of FIG. 5 splits an incident beam into multiple output beams to be emitted from tips 172 and 174, or combines multiple input beams from tips 172, 174 into a single output beam. A plurality of separate trimmed tapers 176, 178 are provided as well in the example of FIG. 5, with each separate trimmed taper provided separate from, but adjacent to, one of the tips 172, 174 of the Y-junction 170. The separate beams from tips 172 and 176 are provided into each corresponding separate trimmed taper. Thus, the beam from tip 172 is provided into separate trimmed taper 176, and the beam from tip 174 is provided into separate trimmed taper 178, or vice versa for optical signals being transmitted in the opposite direction and combined together by the Y-junction. In the end, the trimmed tapers 176 and 178 may merge the beam into one mode. The dimensions of and gap between the trimmed tapers 176 and 178 can define the mode profile of the optical beam.

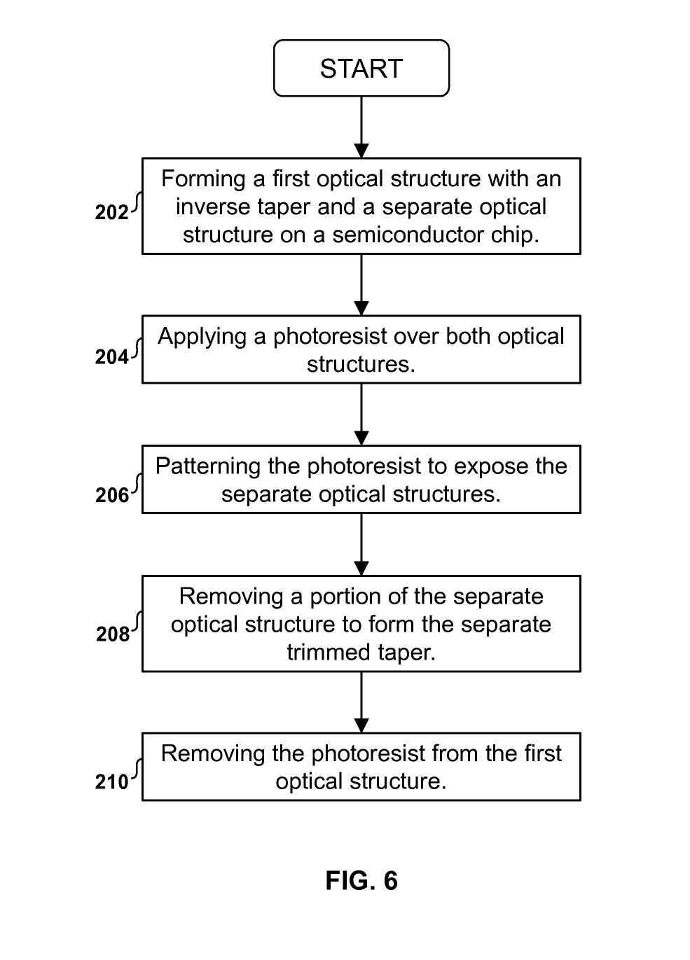

FIG. 6 illustrates a method for fabricating an edge coupling device that includes an optical structure and a separate trimmed taper, examples of which are shown in FIGS. 2-5 and discussed above. The method of FIG. 6 is a semiconductor-based process. The various processing steps can be performed in the order shown, or in a different order. The method may be implemented to increase a mode size of edge coupling device (e.g., edge coupling device 112 of FIG. 1) on the PIC (e.g., PIC 110 of FIG. 1) to correspond to a mode size of the optical component (e.g., optical component 102 of FIG. 1) external to the PIC.

At 202, the method includes forming a first optical structure with an inverse taper and a separate optical structure on a semiconductor chip. The first optical structure may include any suitable optical structure such as a waveguide, a power splitter, or a Y-junction. The first optical structure may correspond, for example, to optical structure 120 shown in FIG. 2. The term “first” is simply included to differentiate the “first” optical structure from the “separate” optical structure. That is, processing step 202 refers to two optical structures, and thus one is referred to as a first optical structure and the other as a separate optical structure. The separate optical structure is further processed to become the separate inverse taper, such as that illustrated in FIGS. 2-5. Any of a variety of semiconductor processes can be employed to form the first and separate optical structures on the semiconductor chip.

Processing steps 204-210 process the separate optical structure to thereby reduce its width and/or height to turn the separate optical structure into an inverse taper, while at the same time protecting the first optical structure from having its width and/or height similarly reduced. At 204, the method includes applying a photoresist over both optical structures (i.e., the first optical structure and the separate optical structure). The photoresist is used as a protective coating for the first optical structure. A hard mask layer can be applied before the photoresist coating. In that way, the photoresist pattern can be transferred to the hard mask, and then the hard mask can be used as a protective coating for the first optical structure. For some trimming methods, the photoresist protection may work better; yet for other trimming methods, the hard mask protection may work better.

At 206, the method includes patterning the photoresist to uncover the separate optical structure while the photoresist remains as a coating over the first optical structure. In one example, patterning the photoresist includes performing various steps such as applying a mask over the semiconductor chip such that patterns (e.g., apertures, transparent portions) in the mask are aligned over or with portions of the photoresist that are to be removed. Because the mask is impervious to ultraviolet (UV) light, the portions of the photoresist not aligned with the patterns in the mask are protected and therefore unaffected by the UV light. The photoresist covering the separate optical structure will be exposed to the UV light through the patterns in the mask, while the photoresist covering the first optical structure is protected by the mask and thus that portion of the photoresist cannot be exposed to the UV light. The photoresist covering the separate optical structure is exposed to the UV light, which chemically degrades the photoresist. The degraded photoresist covering the separate optical structure then can be removed by application of a developer, which chemically interacts with the degraded photoresist. At this point, the photoresist covering the first optical structure remains in place (due to protection by the mask), while the photoresist covering the separate optical structure has been removed. As an alternative to using the photoresist as the protective layer, a hard mask layer can be applied before the photoresist coating. This way, the lithography first patterns the photoresist. The photoresist pattern then can be transferred to the hard mask, and then the hard mask can be used as a protective coating for the first optical structure. For some trimming methods, the photoresist protection works better; yet for other trimming methods, the hard mask protection works better.

At 208, the method further includes removing a portion of the separate optical structure to form the separate trimmed taper which, as explained above, is separate from, but adjacent to, the first optical structure. Removal of the portion of the separate optical structure may be performed by applying an etchant in some embodiments. The etchant preferably is a material that chemically interacts with the material (e.g., silicon) forming the separate optical structure. The volume of material removed from the separate optical structure can be controlled, at least in part, by the type of etchant used and the amount of time the etchant is permitted to remain in contact with the separate optical structure. In other embodiments, the portion of the separate optical structure may be performed through thermal oxidation. In this embodiment, the semiconductor chip (with the separate optical structure) is warmed (e.g., by placement in a warming chamber). The heat causes the outer surface of the separate optical structure to oxidize, which effectively reduces the remaining size of the separate optical structure with the oxide forming a protective layer of the optical structure.

At 210, the method includes removing the protective photoresist or hard mask from the first optical structure. This processing step may be performed through use of an etchant that chemically reacts with the particular photoresist or hard mask used to cover the optical structures.

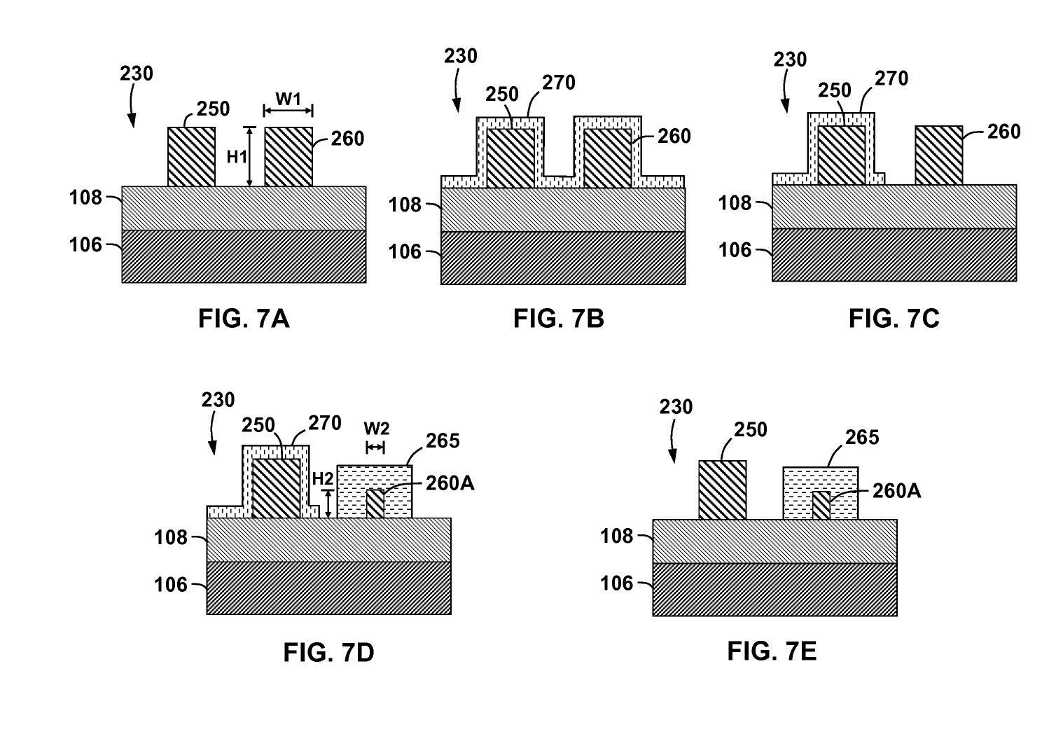

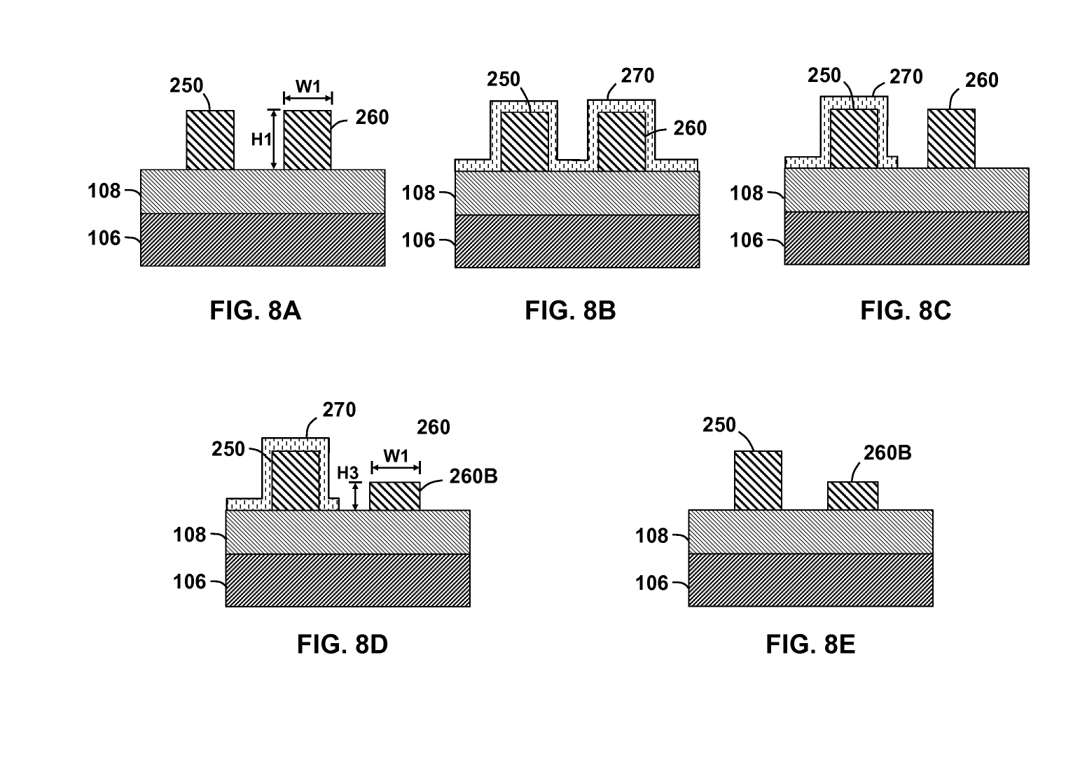

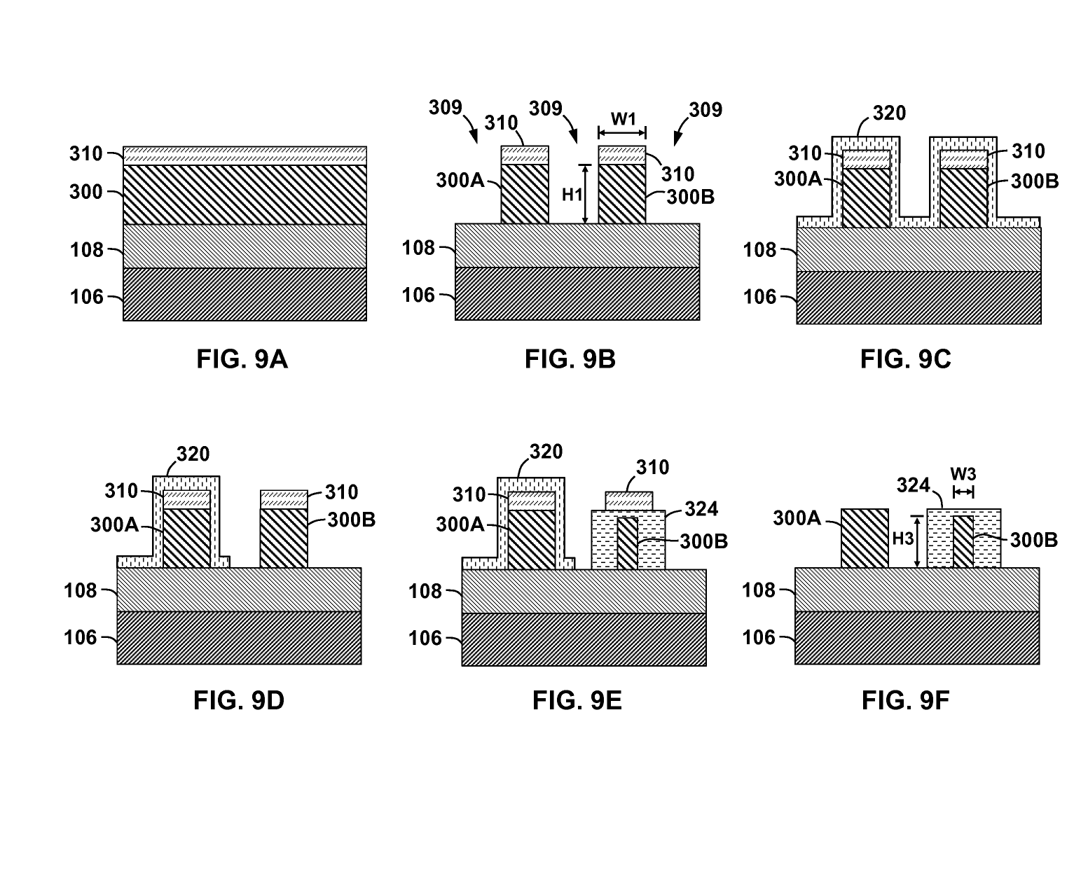

As explained above, the separate trimmed taper is formed by starting out with a separate optical structure (separate from the optical structure forming the waveguide, power splitter, Y-junction, etc.) and then processing the separate optical structure so as to make its width and/or height smaller (that is, reduce its cross sectional area). FIGS. 7A-7E illustrate various processing steps by which the width and height of the separate trimmed taper are reduced. The cross-sectional views in FIGS. 7A-7E, as well as in FIGS. 8A-8E and 9A-9F, represent the cross section along dashed line 129 in FIG. 3.

FIG. 7A illustrates a cross sectional view of a PIC 230 including the low index layer 108 formed on top of the semiconductor layer 106. Further, the first optical structure 250 has been formed on the low index layer 108 (refer to step 202 in FIG. 6). The first optical structure 250 may be a waveguide, power splitter, Y-junction, etc. FIG. 7A also shows a separate optical structure 260 formed on the low index layer 108 separate from, but adjacent to, the first optical structure 250.

FIG. 7B illustrates the PIC 230 after a photoresist 270 (or, in the alternative, hard mask) has been applied over the first and separate optical structures 250 and 260 as explained above at steps 204-206 in FIG. 6. The photoresist 270 protects the first optical structure from having its material removed during the processing step in which the material of the separate optical structure 260 is removed.

FIG. 7C illustrates the PIC 230 after performing a patterning process (step 206 in FIG. 6). As can be seen, the photoresist has been removed from the separate optical structure 260 but not the first optical structure 250.

FIG. 7D illustrates the PIC 230 after a portion of the separate optical structure has been removed to form the separate trimmed taper (step 208 in FIG. 6). In the example of FIG. 7D, an oxidation process has been performed to oxidize the outer surface of the separate optical structure thereby reducing the width and the height of that structure. An oxidation layer 265 thus is formed as shown. In FIG. 7A, the height of the separate optical, before the oxidation occurs, is designated as H1 and the width is designated as W1. In FIG. 7D, following oxidation, the width is W2 and the height is H2. W2 is less than W1 and H2 is less than H1. That is, following oxidation the separate trimmed taper is smaller, both in terms of width and height, than the separate optical structure before oxidation. The separate trimmed taper in FIG. 7D is designated as 260A.

FIG. 7E illustrates the PIC 230 following removal of the photoresist 270 from the first optical structure 250.

FIGS. 8A-8E are similar, but not identical, to FIGS. 7A-7E. In the processing example depicted in FIGS. 8A-8E, the separate optical structure 260 has been formed so as to maintain its width unchanged but its height is reduced. FIGS. 8A-8C are the same as for FIGS. 7A-7C described above. A photoresist 270 has been applied to both optical structures 250, 260 as illustrated in FIG. 8B. The photoresist has been patterned in FIG. 8C so as to remove the photoresist from the separate optical structure 260, but not the first optical structure 250.

FIG. 8C illustrates the removal of a portion of the separate optical structure through application of an etchant. The height of the separate optical structure 260B has been reduced, but not its width, W1. The resulting height is designated as H3, which is smaller than the initial height, H1.

FIGS. 9A-9F illustrate various processing steps in the formation of the separate trimmed taper to reduce its width, but not the height (although the height may be reduced slightly as well). FIG. 9A illustrates the formation of a stack of material. The material stack includes the semiconductor layer 106, the low index layer 108, another semiconductor layer 300, and a photoresist (or hard mask) 310 applied over the semiconductor layer 300. Following a photoresist patterning processing step, the resulting PIC is shown in FIG. 9B. A mask has been applied to permit the photoresist to be exposed to UV light in certain regions 309. The photoresist in regions 309 may be removed by a developer and the semiconductor material underneath the photoresist removed by application of an etchant. The photoresist 310 remains in place as shown to thereby form the first optical structure 300A and the separate optical structure 300B.

FIG. 9C illustrates a second photoresist (or hard mask) 320 applied to the PIC. Photoresist 320 preferably covers both the first optical structure 300A and the separate optical structure 300B as shown. A second patterning processing step is then performed to remove the second photoresist 320 over the separate optical structure 300B. This processing step removes the second photoresist without also removing the initial photoresist 310 covering the separate optical structure 300B. Removal of the second photoresist 320 without also removing the initial photoresist 310 may be accomplished through use of an etchant that chemically interacts with the second photoresist 320 but not the initial photoresist 310.

The PIC is then warmed at a temperature level so as to cause an oxidation process to occur on the second optical structure 300B. Because the second optical structure 300B is still covered by photoresist (which may have only a little oxygen in it), the sides of the optical structure 300B oxidizes more than the top. An oxidation layer 324 is formed as shown. As a result, the width of the second optical structure 300B is decreased more than the height as shown in FIG. 9E. The width W3 of the resulting separate trimmed taper is smaller than its initial width W1. Once a desired width W3 of the separate trimmed taper is obtained, the oxidation process is terminated, and the photoresists 310 and 320 are removed as indicated in FIG. 9F.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1.-10. (canceled)

11. An apparatus comprising:
an optical structure configured to pass light therethrough, the optical structure including an inverse taper defining an optical mode; and
a separate trimmed taper spaced apart from, but adjacent to, the inverse taper of the optical structure,
wherein the separate trimmed taper defines an optical mode,
wherein the optical mode of the separate trimmed taper is larger than the optical mode of the inverse taper of the optical structure, and
wherein the separate trimmed taper overlaps the inverse taper of the optical structure.

12. The apparatus of claim 11, wherein the optical structure is selected from the group consisting of a waveguide, a power splitter, and a Y-junction.

13. The apparatus of claim 11, wherein the optical structure includes a plurality of inverse tapers, wherein the apparatus further includes a plurality of separate trimmed tapers.

14. The apparatus of claim 13, wherein one of the separate trimmed tapers is provided separate from, but adjacent to, one of the inverse tapers of the optical structure, and another of the separate trimmed tapers is provided separate from, but adjacent to, another inverse taper of the optical structure.

15.-20. (canceled)

21. An apparatus comprising:
a waveguide including an inverse taper defining an optical mode; and
a trimmed taper spaced apart from, but adjacent to, the inverse taper of the optical structure, wherein the trimmed taper defines an optical mode,
wherein the optical mode of the trimmed taper is larger than the optical mode of the inverse taper of the waveguide, and
wherein the trimmed taper overlaps the inverse taper of the waveguide.

22. The apparatus of claim 21, wherein the waveguide includes more than one inverse taper.

23. The apparatus of claim 21, wherein the apparatus includes more than one trimmed taper.
